(19) United States
(12) Patent Application Publication
(10) Pub. No.: US 2010/0156768 A1
(43) Pub. Date: Jun. 24, 2010

(54) DISPLAY MEDIA, METHOD OF FORMING DISPLAY MEDIA, AND PRINTER FOR PRINTING ON DISPLAY MEDIA

(76) Inventors: James Douglas Fletcher, II, Bartlett, TN (US); Gary J. Marsh, Rutherford, NJ (US)

Correspondence Address: FROMMER LAWRENCE & HAUG, 745 FIFTH AVENUE- 10TH FL., NEW YORK, NY, 10151, US

(21) Appl. No.: 12/341,181

(22) Filed: Dec. 22, 2008

(51) Int. Cl. G09G 3/36; B05D 5/12; B05C 11/00

(52) U.S. Cl. 345/87; 427/66; 118/697

(57) ABSTRACT

A display media is disclosed which includes (1) a first flexible sheet, (2) a second flexible sheet, (3) a display activation substance located between the first and second flexible sheets, (4) a relatively transparent conductive layer located directly adjacent to the first flexible sheet, (5) a display controller located on a first surface of the second flexible sheet, (6) a plurality of electrodes located on the first surface, each of the plurality of electrodes being connected to the display controller, and (7) an additional electrode located on the first surface, the additional electrode being connected to both the display controller and the conductive layer. In this embodiment, the first surface faces away from the display activation substance. In addition, a one of the first and second flexible sheets, located nearest to a side of the display media through which a viewer is intended to view the pattern, is clear.

### BACKGROUND OF THE INVENTION

1. Field of the Invention

The present application relates to display media and a printer, where the printer prints a pattern/graphics onto the display media using a conductive material, and, using the same conductive material, attaches portions of these graphics to prearranged electrodes on the display media. The prearranged electrodes are in turn attached to a controller chip on the display media.

2. Description of Related Art

Previously, electronic signage and displays have been created by printing a graphic onto a substrate to create a backplane. The backplanes have been created by an electronic manufacturing process in which a pattern is placed onto a first copper sheet laminated to an insulating material. The first copper sheet is dipped into an etching solution so that areas around the pattern are etched away. This first etched copper sheet becomes the backplane. Next a display material is applied on top of the first etched copper sheet to create the display.

Electronic signage and displays usually include several layers of etched copper sheets and insulating layers. The top layer contains the desired graphic/signage pattern while additional layers contain electronic circuitry to route pattern signals. In other words, before the display material is applied, a second etched copper sheet is created and laminated to the first insulating layer. Then a second insulating layer is laminated on top of the second etched copper sheet. This process is then repeated until the desired layers of etched copper sheets and insultingly layers have been laminated together, creating a finished backplane.

This finished backplane may then be incorporated in the desired signage or display device (e.g., a liquid crystal display (“LCD”) or electrophoretic display) by applying the appropriate display material to the top layer with the graphic/signage pattern in order to actually display the desired graphic, as the backplane is incapable of displaying the desired graphic by itself.

However, the creation of the above backplane is expensive and time consuming, as it must be manufactured. In addition, the entire backplane must be redesigned and retooled when a different graphic is desired. This requires even more expense and time.

Therefore, a need has arisen for electronic signage and displays which require less expense and time to create.

### SUMMARY OF THE INVENTION

In accordance with one embodiment of the invention, a display media on which a conductive pattern is to be printed is disclosed. This display media includes (1) a first flexible sheet, (2) a second flexible sheet, (3) a display activation substance located between the first flexible sheet and the second flexible sheet, (4) a relatively transparent conductive layer located directly adjacent to the first flexible sheet, (5) a display controller located on a first surface of the second flexible sheet, (6) a plurality of electrodes located on the first surface of the second flexible sheet, each of the plurality of electrodes being connected to the display controller, and (7) an additional electrode located on the first surface of the second flexible sheet, the additional electrode being connected to both the display controller and the conductive layer. In this embodiment, the first surface of the second flexible sheet faces away from the display activation substance. In addition, a one of the first and second flexible sheets, located nearest to a side of the display media through which a viewer is intended to view the pattern, is clear.

In accordance with another embodiment of the invention, a method for printing on display media is disclosed. Several steps are involved in this method. One step is to print conductive material so as to form a conductive pattern on a print surface of the display media. Another step is to print conductive material so as to form a conductive trace on the print surface of the display media. In this embodiment, the display media includes (1) a first flexible sheet, (2) a second flexible sheet, (3) a display activation substance located between the first flexible sheet and the second flexible sheet, (4) a relatively transparent conductive layer located directly adjacent to the first flexible sheet, (5) a display controller located on a first surface of the second flexible sheet, and (6) a plurality of electrodes located on the first surface of the second flexible sheet, each of the plurality of electrodes being connected to the display controller. In this embodiment, the first surface of the second flexible sheet faces away from the display activation substance. In addition, a one of the first and second flexible sheets, located nearest to a side of the display media through which a viewer is intended to view the pattern, is clear. Moreover, the conductive trace is connected to both a portion of the conductive pattern and one of the plurality of electrodes.

In accordance with yet another embodiment of the invention, a printer for printing on display media is disclosed. This printer includes (1) a printing device which prints a conductive material onto display media, and (2) read only memory which contains an algorithm, the read only memory being electrically connected to the printing device. In this embodiment, the printing device uses the conductive material to print a conductive pattern onto the display media. In addition, the printing device uses the conductive material to print a first conductive trace onto the display media, the first conductive trace being connected to both a first portion of the conductive pattern and a first electrode of a plurality of electrodes located on the display media. Moreover, the printing device uses the algorithm to determine the location at which to print the first conductive trace on the display media, so that the first conductive trace connects to none of the plurality of electrodes other than the first electrode.

### BRIEF DESCRIPTION OF THE DRAWINGS

FIG. 1 is a plan view showing a single sheet of display media.

FIG. 2 is a sectional view of an embodiment of a single sheet of display media taken along line A-A in FIG. 1.

FIG. 3 is a sectional view of portion of a single sheet of display media.

FIG. 4 is a sectional view of a portion of a single sheet of display media.

FIG. 5 is a sectional view of an embodiment of a single sheet of display media taken along line A-A in FIG. 1.

FIG. 6 is a sectional view of an embodiment of a single sheet of display media taken along line A-A in FIG. 1.

FIG. 7 is a sectional view of an embodiment of a single sheet of display media taken along line A-A in FIG. 1.

FIG. 8 is a plan view showing a single sheet of display media with a printed pattern.

FIG. 9 is a plan view showing a single sheet of display media with a printed pattern.

FIG. 10 is a plan view showing a single sheet of display media with a printed pattern.

FIG. 11 is a plan view showing a single sheet of display media with a printed pattern.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements found in conventional display/printing methods and systems. Those of ordinary skill in the art will recognize that other elements are desirable for implementing the present invention. However, because such elements are well known in the art, and because they do not facilitate a better understanding of the present invention, a discussion of such elements is not provided herein.

Referring now to the drawings, the present invention will be described in detail on the basis of exemplary embodiments.

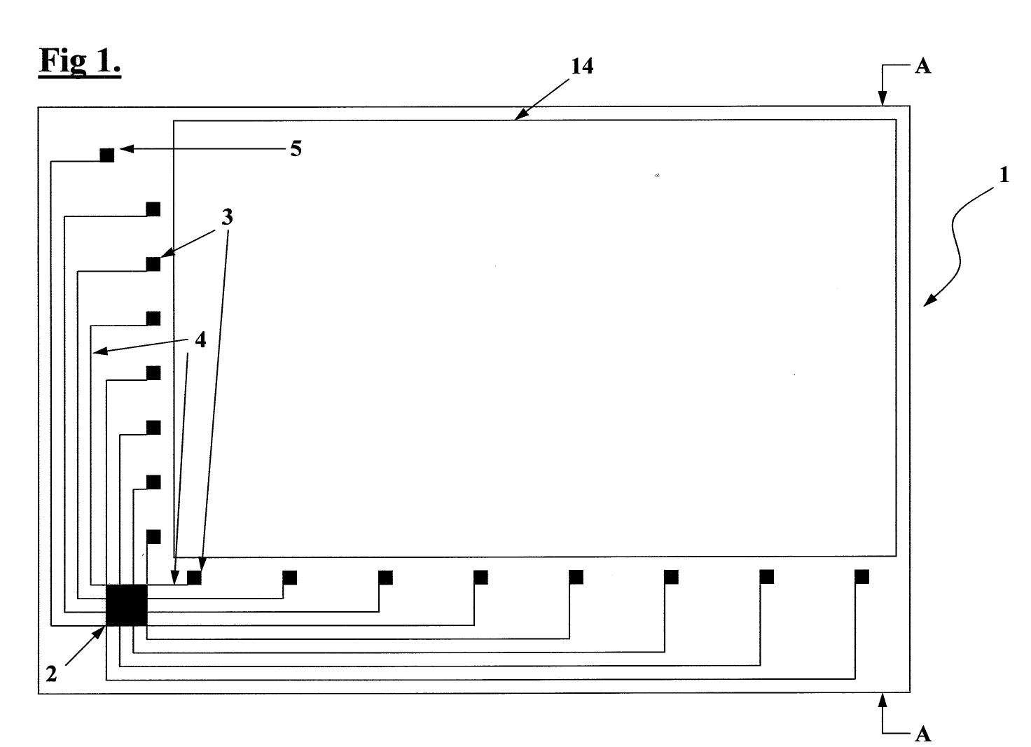

FIG. 1 shows a plan view of a sheet of display media 1 of one embodiment of the current invention. Display media is media which is capable of visually displaying a pattern/graphic. This display media 1 includes a driver chip/display controller 2, multiple electrodes 3, and multiple conductive traces 4. Each of the traces 4 connects one of the electrodes 3 to the display controller 2.

The display controller 2 includes the circuitry required to cause the graphics 15 (see FIG. 8) to be shown. In other words, the display controller 2 includes the circuitry required to activate or supply power to the electrodes 3. This circuitry could be as simple as a switch to connect the power supply to the preprinted conductors, thereby applying power to the graphics 15. Other possible elements of the display controller 2 include: a central processing unit for intelligent control; a logic unit for switching outputs based on a logic condition; a clocking unit to provide a regulated clock to the controller system; a timing unit to control the timing of graphics changes; a read only memory (“ROM”) or flash memory area to hold operating instructions (e.g., a computer program); a random access memory (“RAM”) area to hold variable program elements; a power regulation area to regulate power from the power source; a charge pump to increase or decrease the power sent to the graphic 15; a programming interface to facilitate loading of the controller code (e.g., a computer program). The display controller 2 can be a single self-contained device, or it can be composed of multiple circuit elements.

The display controller 2 can be constructed by microelectronics fabrication (e.g., silicon type fabrication), or it can be constructed by depositing semiconducting, conducting, passive, resistive, inductive, capacitive, and insulating materials directly onto the display media 1. This can include directly printing the display controller onto the media substrate using the printing apparatus and printable electronics such as organic, inorganic, and polymer devices.

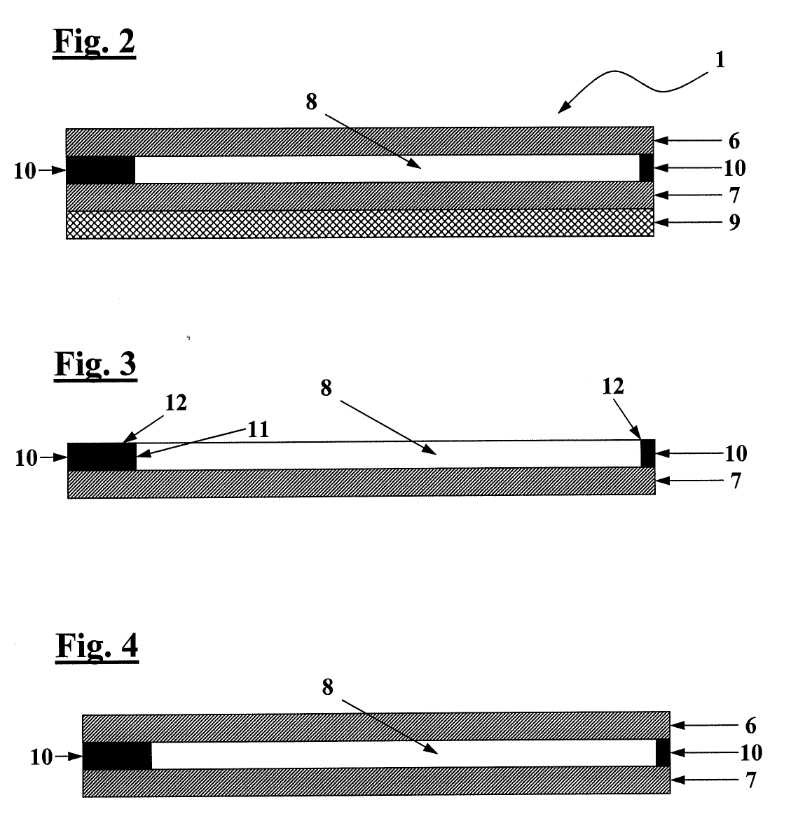

Referring to FIG. 2, the display media 1 is made of several layers. These layers include clear flexible sheets 6, 7, display activation substance 8, and conductive layer 9. The clear flexible sheets 6, 7 may be made from any substance which is relatively transparent or opaque, and is flexible. Examples of materials from which the clear flexible sheets 6, 7 may be made include plastic, polyethylene terephthalate (“PET”), polyethylene naphthalate (“PEN”), and polyamide to name a few.

While the flexible sheets 6, 7 of the current embodiment are both clear, they do not necessarily need to be. In fact, only one of the flexible sheets 6, 7, needs to be clear. In particular, the flexible sheet through which a viewer is intended to view the pattern/graphic of the display media 1 is the only flexible sheet which is required to be clear. Since it may not be intended that the viewer view the pattern/graphic through the other flexible sheet, that other flexible sheet need not be clear.

The display activation substance 8 can be made from any material that can be affected by a change in voltage potential across it so as to create an optical difference in the material, such as an optical color difference (e.g., black/white, black/clear, etc.). The display activation substance 8 may be made from a uni-stable material (e.g., liquid crystal display (“LCD”)), bi-stable material (e.g., electrophoretic material, cholesteric LCD), or emissive material (e.g., electro-luminescent, light-emitting diode (“LED”), organic light-emitting diode (“OLED”), quantum dots). The conductive layer can be made from any conductive material which is relatively transparent or opaque. One such example is indium tin oxide (“ITO”).

As shown in FIG. 3, one way in which the display media 1 may be made is by placing a non-conductive, chemically non-reactive adhesive material 10 on one side of flexible sheet 7. A cavity 11 within the adhesive material 10 may then be formed and hardened. Ways in which the adhesive material 10 may be hardened include use of UV, heat, and epoxy. The display activation substance 8 may then be placed into the cavity 11. Then, the flexible sheet 6 may be adhered to portions 12 of the adhesive material 10 which are distal from the flexible sheet 7.

During the hardening of the adhesive material 10 may be semi-hardened. In this way, the portions 12 of the adhesive material 10 which are distal from the flexible sheet 7 will retain their adhesive properties. Therefore, as shown in FIG. 4, these portions 12 of the adhesive material 10 may be adhered to one side of flexible sheet 6. Alternatively, the adhesive material 10 may be completely hardened. Another layer of adhesive (not shown) may then be applied to the portions 12 of the adhesive material 10 so that these portions 12 may be adhered to one side of flexible sheet 6.

The laminate of the flexible sheets 6, 7, adhesive material 10, and display activation substance 8 is then inspected to ensure the cavity 11 has been filled correctly. For example, an optical densitometer may be used. After the laminate is inspected, the conductive layer 9 is then applied to the flexible sheet 7. Alternatively, the conductive layer 9 may be pre-applied to the flexible sheet 7.

While the embodiment above uses an adhesive material 10 to create a cavity in which to place the display activation substance 8, the invention is not limited thereto. For example, the display activation substance may be applied to the flexible sheet 7 as a paste that only flows when there is a voltage placed across the display activation substance. In this case, the display activation substance will soften and flow when a voltage is placed across it. Thus, cavities are not necessary, as the display activation substance is a phase change material that changes from a higher viscosity to a lower viscosity when there is a voltage applied across it or an electric field within it. After this type of display activation substance is pasted on the flexible sheet 7, the flexible sheet 6 may be applied at a known distance from the flexible sheet 7 to create the laminate. The phase change material is not limited to voltage activation, but may be any other known or unknown method such as heat, UV, etc.

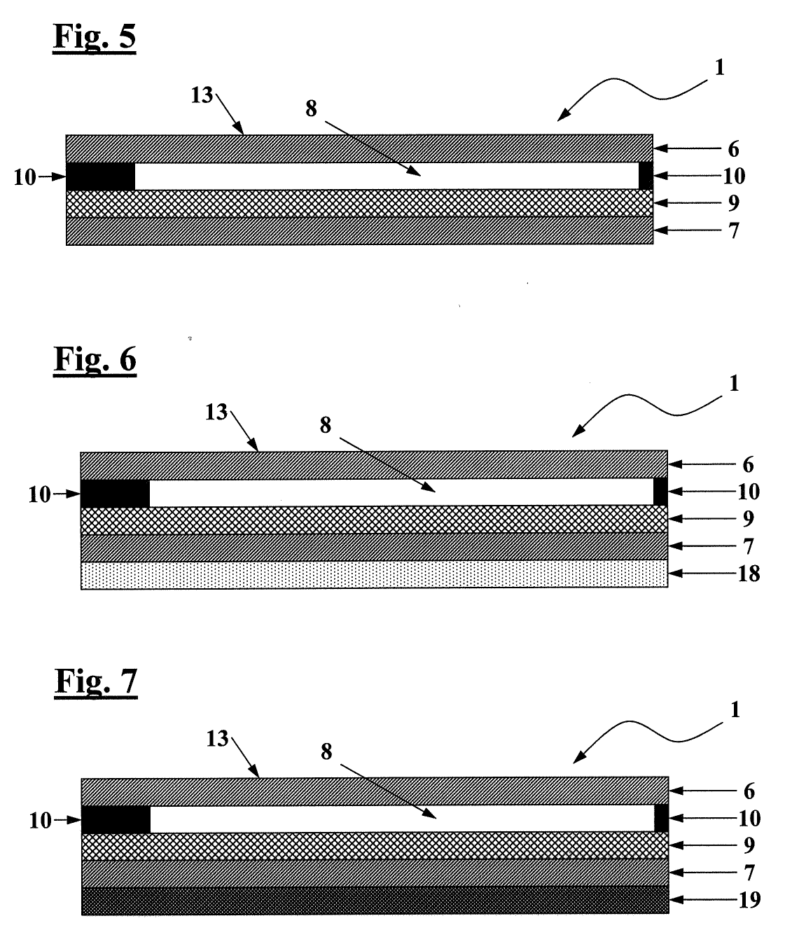

In addition, while the conductive layer 9 is located on a side of the flexible sheet 7 distal from the display activation substance 8, the invention is not limited thereto. For example, as shown in FIG. 5, the display media 1 may be configured such that the conductive layer 9 is located on a side of the flexible sheet 7 adjacent to the display activation substance 8.

After the laminate of the flexible sheets 6, 7, adhesive material 10, display activation substance 8, and conductive layer 9 has been created, then the display controller 2, multiple electrodes 3, and multiple traces 4 are attached to the side 13 of the flexible sheet 6 distal from the display activation substance 8. Each electrode 3 is located at a predetermined reference location on the media substrate. Each of the traces 4 connects one or more of the electrodes 3 to the display controller 2. While FIG. 1 depicts each of the electrodes 3 having a separate trace 4 connected to the display controller 2, multiple electrodes 3 may be connected to a single trace 4.

While FIG. 1 seems to depict the electrodes 3 as being separate from the traces 4, it should be noted that the ends of the traces 4 themselves may act as the multiple electrodes 3. Therefore, the electrodes 3 may be a part of the traces 4.

An additional electrode 5 is placed on the flexible sheet 6 outside of the display field area 14. This additional electrode 5 is connected to both the display controller 2 and the conductive layer 9. This connection can be accomplished by drilling a hole through the display media 1 in order to connect the additional electrode 5 to the conductive layer 9. The additional electrode 5 can be connected to the conductive layer 9 at one point or at multiple points. Moreover, there may be provided multiple electrodes 5, each of which being connected to the conductive layer 9 at one point or at multiple points.

FIG. 6 depicts another embodiment of the current invention. In this embodiment, the display media 1 additionally includes an optical enhancing layer 18 (see FIG. 6). The optical enhancing layer 18 enhances the way in which patterns/graphics 15 (see FIG. 8) are viewed by an observer. The location of the optical enhancing layer 18 can differ from that depicted in FIG. 6, so long as the optical enhancing layer 18 is located the side of the display activation substance 8 which will be viewed by an observer. In other words, the location of the optical enhancing layer 18 must be such that the optical enhancing layer 18 is located on/in the display media 1 at a position between the display activation substance 8 and an observer. In this way, an observer will view the display activation substance 8 through the optical enhancing layer 18, thereby allowing the optical enhancing layer 18 to enhance the way in which patterns/graphics 15 displayed in the display activation substance 8 are viewed by an observed.

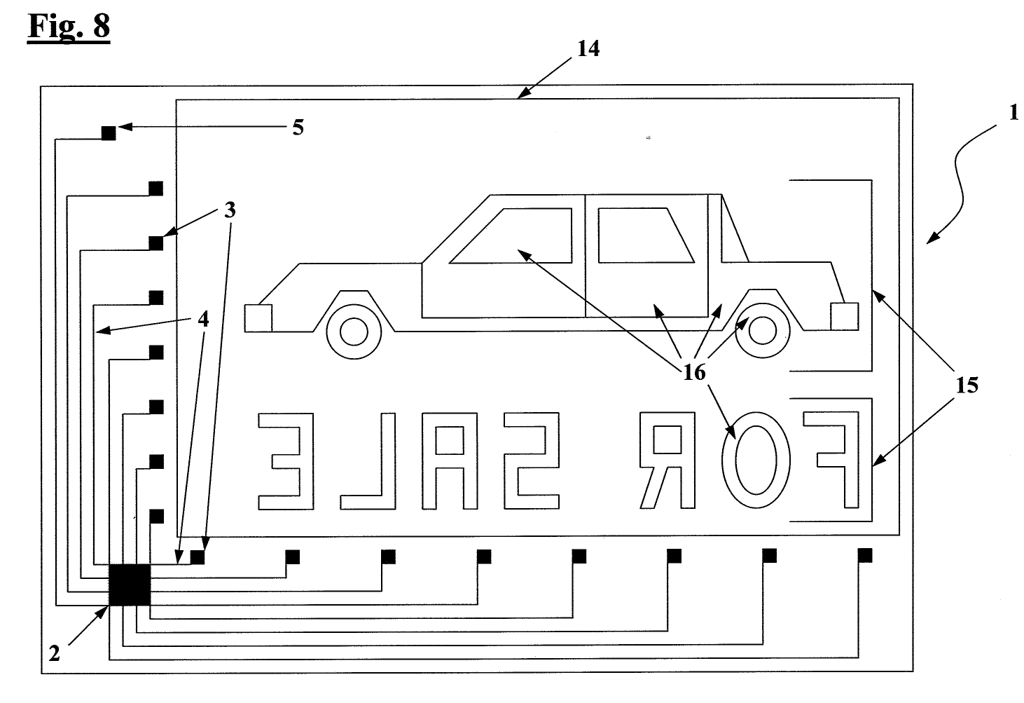

FIG. 7 depicts another embodiment of the current invention. In this embodiment, the display media 1 also includes an adhesive layer 19. The adhesive layer 19 serves to attach the display media 1 to a surface on which the display media 1 will be displayed. The location of the adhesive layer 19 can differ from that depicted in FIG. 7, so long as the adhesive layer 19 is located on the side of the display media 1 which will be attached to a surface on which the display media 1 will be displayed.

The adhesive layer 19 may be semitransparent. Whether or not the adhesive layer 19 must be semitransparent is determined by the side of the display media 1 on which the adhesive layer 19 is located. Similarly to the flexible sheets 6, 7, the adhesive layer 19 must be semitransparent if it is to be located on the side of the display media 1 through which a viewer is intended to view the pattern/graphic of the display media 1. Since it may not be intended that the viewer view the pattern/graphic through the other side of the display media 1, any adhesive layer 19 located on that side of the display media 1 may be semitransparent or opaque.

Once the display media 1 has been created, the patterns/graphics 15 for the desired signage/display are printed on the print side of the display media 1. In the current embodiment, the print side of the display media 1 is the side 13 of the flexible layer 6 which is distal from the display activation substance 8.

In order to print the graphics onto the display media 1, the display media 1 is placed in a printer. The firmware of the printer is able to determine the size of the display media 1. The firmware can then determine the type of the display media 1 by the size of the display media 1. In this way, the printer can determine the location of the electrodes 3 as well as the location of the display field area 14. The firmware also contains elements that aid in locating a reference position on the display media 1 (edge detection, page registration, fiducial recognition, etc.) The printer could also contain a lookup table or database so that different numbers and locations of electrodes 3 may be selected. Once the printer determines the size and type of the display media 1, the printer then prints conductive material on the print side of the display media 1 so as to form the graphics for the desired signage/display.

The printed conductive material can be organic (e.g., poly(3,4-ethylenedioxythiophene)poly(styrenesulfonate) (“PEDOT:PSS”)), inorganic particles (e.g., indium tin oxide (“ITO”), silver, aluminum, copper, gold, platinum, carbon, etc.), or solid materials (e.g., silver, aluminum, copper, etc.)

Similarly, the flexible sheets 6, 7, the conductive layer 9, the optical enhancing layer 18, and the adhesive layer 19, if applied to flexible layer 6, are each at least 75% transparent, more preferably at least 85% transparent, even more preferably at least 95% transparent.

The type of printer used is not to be limited, so long as the printer is capable of printing the conductive material. Examples of suitable types of printers include laser printers, ink-jet printers, bubble jet printers, metallic foil transfer printers, cold lamination printers, and heat lamination printers.

The graphics to be printed on the display media 1 can consist of text, images, or anything else which is printable. FIG. 8 depicts one example of graphics 15 which may be printed on the print side of the display media 1. In FIG. 8, the graphics 15 are a depiction of a car and the words “FOR SALE” printed in mirror image. The graphics are printed in mirror image so that the graphics may be readily interpreted from the viewing side of the display media 1, which is opposite to the print side 13. While the above embodiment describes the viewing side of the display media 1 is opposite to the print side 13 of the display media 1, the current invention is not limited thereto. For example, the viewing side of the display media 1 may coincide with the print side 13 of the display media 1. In such a case, the graphics would not need to be printed in mirror image. However, the printed conductive material in this case should be 75% transparent, more preferably at least 85% transparent, even more preferably at least 95% transparent.

At the same time the printer prints the graphics onto the display media 1, the printer also uses the conductive material to print conductive traces 17. Each printed conductive trace 17 connects one of the outlined portions/areas 16 of the printed graphics 15 to one of the electrodes 3. Each of the outlined areas 16 are electrically isolated from each other. The outlined areas 16 which are indicated in FIG. 8 are only meant to be illustrative examples of outlined areas 16, and are not meant to be a complete indication of all of the outlined areas 16 of the printed graphics 15.

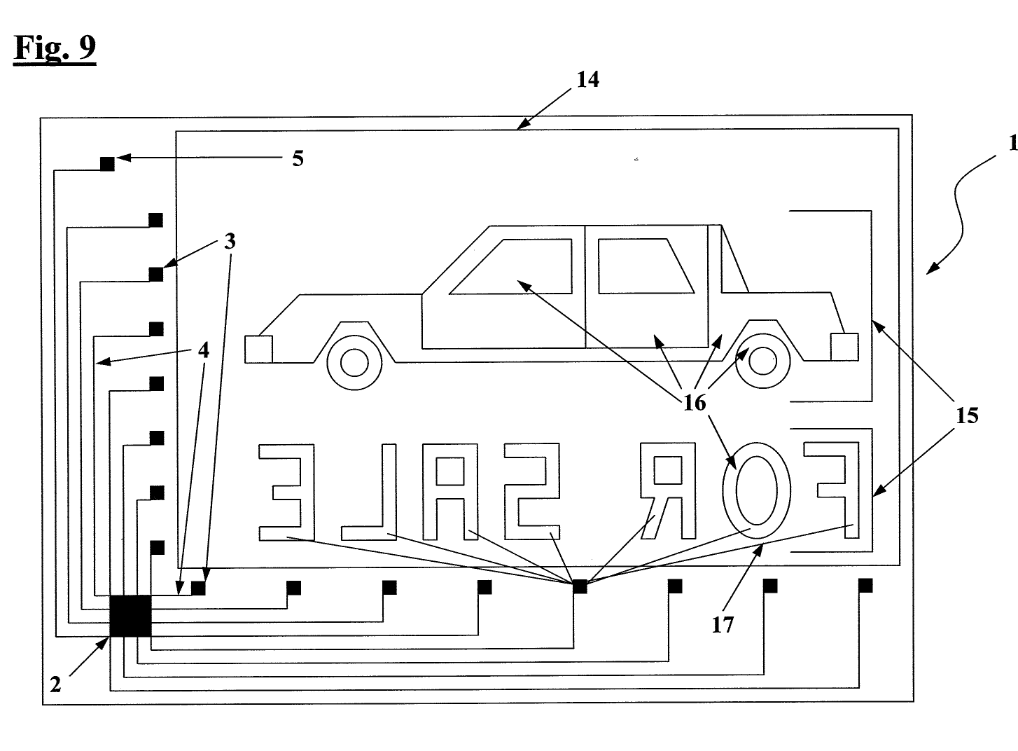

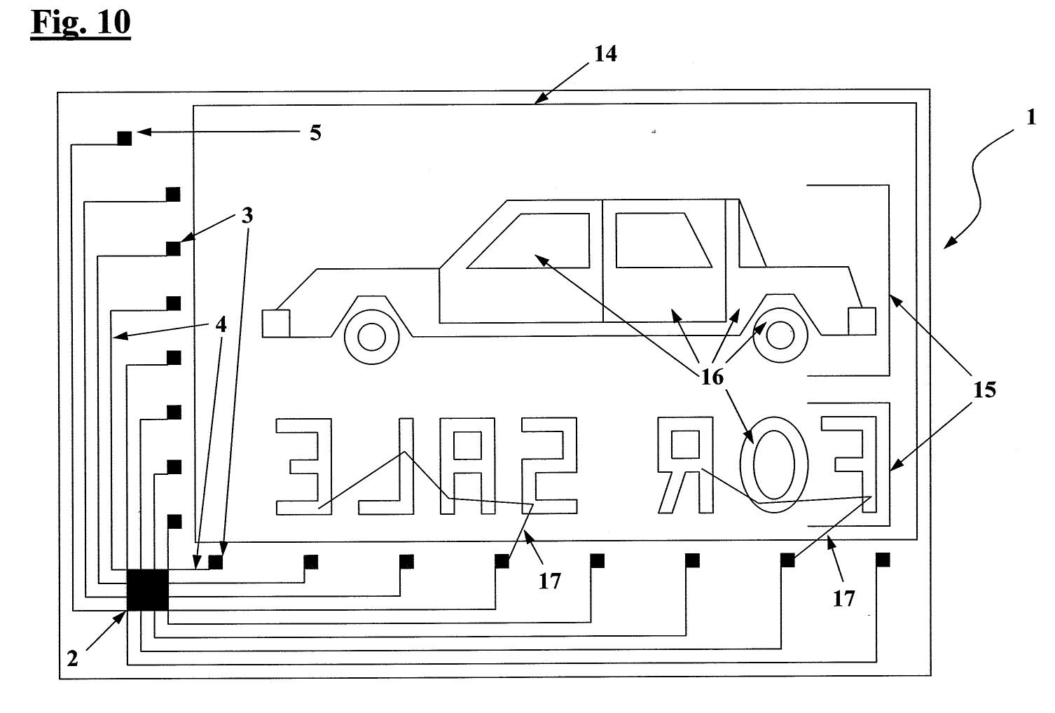

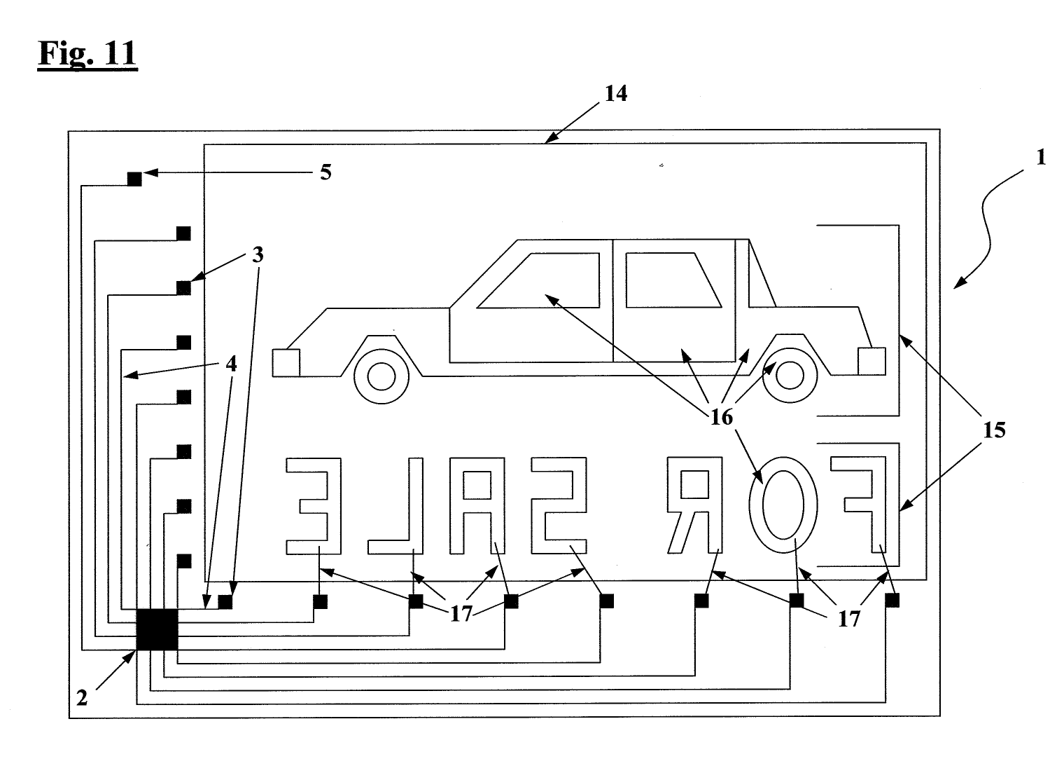

One electrode may be connected to more than one outlined area 16. In this way, by using the display controller 2 to activate one of the electrodes 3, it is possible to simultaneously activate multiple outlined areas 16. FIG. 9 depicts one such example of a single electrode 3 being connected to multiple outlined areas 16 via conductive traces 17. FIG. 10 depicts another example of a single electrode 3 being connected to multiple outlined areas 16 via conductive traces 17. However, if it is desirable to control the activation of the outlined areas 16 separately, then each electrode can be connected to only one outlined area 16. FIG. 11 depicts just such an embodiment where the electrodes 3 are connected to only one outlined area 16.

In the above described embodiment, only the outlined areas 16 of the printed graphics 15 are connected to the electrodes 3. However, the portion of the display field area 14 separate from the graphics 15 can also be connected to the electrodes 3. As mentioned above, the outlined areas 16 of the printed graphics 15 are electrically isolated from each other. As such, the printed graphic itself is electrically isolated from the rest of the display field area 14 (“the background”). Accordingly, just as the printed graphics 15 can be connected to an electrode 3 so as to be activated, so can the background area of the display field area 14 be connected to an electrode 3 so as to be activated.

The printer may be used for more than just printing the graphics 15 and the conductive traces 17. For example, the printed can also be configured to print a power source onto the display media 1, as well as to print a protective or insulating film, or barrier layer, onto the display media 1. Materials such as lithium based polymers, lithium based gels, and manganese dioxide/zinc compounds are known materials used to print power sources. The power source consists of a single element or multiple elements used to power the display system so as to cause the graphics 15 to be displayed. The power source does not have to be printed onto the display media 1, and may be applied to the display media 1 in some other fashion. The power source could be applied after the graphics 15 and conductive traces 17 have been printed onto the display media 1, or the power source can be an integral part of the display media 1 itself.

The printer additionally includes an algorithm stored in read only memory (“ROM”) or flash memory. The algorithm determines how to print the graphics 15 and the conductive traces 17 onto the display media 1 so that no lines are bisected. Alternatively, the algorithm may be included in a computer which is in communication with the printer.

The algorithm can be configured such that a user inputs the graphics 15 into a computer. The user then uses the computer to highlight each outlined area 16 which the user whishes to be activated by the display controller 2, and inputs the time intervals for switching between activation states (e.g., an on state where electricity is supplied to the respective outlined areas 16, and an off state where electricity is not supplied to the respective outlined areas 16). The algorithm then utilizes the user choices (i.e., graphics 15, outlined areas 16, and time intervals) to determine how to print the graphics 15 and the conductive traces 17 so that no traces/lines are bisected, and so that all of the selected outlined areas 16 are connected to the appropriate electrodes 3.

The display controller 2 can be configured before hand so as to activate each of the multiple electrodes 3 at set time intervals. In such a situation, the user would have a limited number of options on the computer when inputting the time intervals for switching between activation states. In addition, the selection of the various activation states would determine which electrodes 3 must be connected to the respective outlined areas 16. For example, if it is desired to activate a particular outlined area 16 every twenty seconds, then that particular outlined area 16 must be connected to an electrode 3 which has been pre-configured to activate every twenty seconds. This may require an electrode located at one far end of the display media 1 to be connected to a particular outlined area 16 located at the opposite far end of the display media 1.

Conversely, the display controller can be configured by the printer during the printing process via either contact or contactless methods (e.g., radio frequency). In such a situation, the user would have many more options when inputting the time intervals for switching between activation states. This would allow for a greater flexibility when selecting the time intervals for switching between activation states of each of the electrodes 3. For example, if it is desired to activate a particular outlined area 16 every twenty seconds, then the display controller 2 can be configured so as to activate an electrode 3 which is nearest to that particular outlined area 16. This would simplify the connections that need to be made between the electrodes 3 and the various outlined areas 16.

The above embodiments describe the display media as being in sheet form. However, the current invention is not limited thereto. For example, the display media may be in the form of a roll.

The above embodiments describe single conductive traces being formed between any two given points, or between a given outlined area and an electrode. However, the current invention is not limited thereto. For example, multiple conductive traces can be formed between a single outlined area and a single electrode. In this way, the multiple traces would act as a fail safe so that a given outlined area can be activated even if one of the traces fails.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

What is claimed is:

1. Display media on which a conductive pattern is to be printed, comprising:
a first flexible sheet;
a second flexible sheet;
a display activation substance located between the first flexible sheet and the second flexible sheet;
a relatively transparent conductive layer located directly adjacent to the first flexible sheet;
a display controller located on a first surface of the second flexible sheet; and
a plurality of electrodes located on the first surface of the second flexible sheet, each of the plurality of electrodes being connected to the display controller; and
an additional electrode located on the first surface of the second flexible sheet, the additional electrode being connected to both the display controller and the conductive layer;
wherein the first surface of the second flexible sheet faces away from the display activation substance; and
wherein a one of the first and second flexible sheets, located nearest to a side of the display media through which a viewer is intended to view the pattern, is clear.

2. The display media according to claim 1;
wherein the display controller determines the timing of the flow of electricity to each of the plurality of electrodes.

3. The display media according to claim 1;
wherein the conductive layer is located on a first surface of the first flexible sheet; and
wherein the first surface of the first flexible sheet faces away from the display activation substance.

4. The display media according to claim 1;
wherein the conductive layer is located on a second surface of the first flexible sheet; and
wherein the second surface of the first flexible sheet faces towards the display activation substance.

5. The display media according to claim 1;
wherein a conductive pattern is printed on the first surface of the second flexible sheet;
wherein a first conductive trace is printed on the first surface of the second flexible sheet; and
wherein the first conductive trace is connected to both a first portion of the conductive pattern and a first electrode of the plurality of electrodes.

6. The display media according to claim 5;
wherein the first conductive trace is connected to a plurality of portions of the conductive pattern.

7. The display media according to claim 5;
wherein a second conductive trace is printed on the first surface of the second flexible sheet; and
wherein the second conductive trace is connected to both a second portion of the conductive pattern and the first electrode of the plurality of electrodes, the second portion of the conductive pattern being electrically isolated from the first portion of the conductive pattern; and
wherein the second conductive trace does not intersect with, and is electrically isolated from, the first conductive trace or the first portion of the conductive pattern.

8. The display media according to claim 1, further comprising:
a first barrier layer which protects the display media from damage; and
wherein the one of the first and second flexible sheets is located between the first barrier layer and the other of the first and second flexible sheets.

9. The display media according to claim 1, further comprising:
a first barrier layer which protects the display media from damage; and
a second barrier layer which protects the display media from damage;
wherein both the first flexible sheet and the second flexible sheet are located between the first barrier layer and the second barrier layer.

10. The display media according to claim 1, further comprising:
an optical enhancing layer;
wherein the display activation substance is located between the second flexible sheet and the optical enhancing layer.

11. The display media according to claim 1, further comprising:
an adhesive layer located on an outer side of the display media distal from the second flexible sheet.

12. The display media according to claim 1, further comprising:
an adhesive layer located on an outer side of the display media distal from the first flexible sheet.

13. The display media according to claim 1, further comprising:
an additional electrode located on the first surface of the second flexible sheet, the additional electrode being connected to both the display controller and the conductive layer.

14. A method for printing on display media, comprising:
printing conductive material so as to form a conductive pattern on a print surface of the display media; and
printing conductive material so as to form a conductive trace on the print surface of the display media;
wherein the display media comprises:
a first flexible sheet;
a second flexible sheet;
a display activation substance located between the first flexible sheet and the second flexible sheet;
a relatively transparent conductive layer located directly adjacent to the first flexible sheet;
a display controller located on a first surface of the second flexible sheet; and
a plurality of electrodes located on the first surface of the second flexible sheet, each of the plurality of electrodes being connected to the display controller;
wherein the first surface of the second flexible sheet faces away from the display activation substance; and
wherein a one of the first and second flexible sheets, located nearest to a side of the display media through which a viewer is intended to view the pattern, is clear; and
wherein the conductive trace is connected to both a portion of the conductive pattern and one of the plurality of electrodes.

15. The method for printing on display media according to claim 14, further comprising:
printing a power source on the print surface of the display media.

16. The method for printing on display media according to claim 14, further comprising:
printing an electrically insulating material on the print surface of the display media after both the conducive pattern and the conductive trace have been printed on the print surface of the display media.

17. The method for printing on display media according to claim 14, further comprising:
programming the display controller after both the conducive pattern and the conductive trace have been printed on the print surface of the display media.

18. A printer for printing on display media, comprising:
a printing device which prints a conductive material onto display media; and
read only memory which contains an algorithm, the read only memory being electrically connected to the printing device;
wherein the printing device uses the conductive material to print a conductive pattern onto the display media;
wherein the printing device uses the conductive material to print a first conductive trace onto the display media, the first conductive trace being connected to both a first portion of the conductive pattern and a first electrode of a plurality of electrodes located on the display media;
wherein the printing device uses the algorithm to determine the location at which to print the first conductive trace on the display media, so that the first conductive trace connects to none of the plurality of electrodes other than the first electrode.

19. The printer for printing on display media according to claim 18;
wherein the printing device uses the conductive material to print a second conductive trace onto the display media, the second conductive trace being connected to both a second portion of the conductive pattern and a second electrode of the plurality of electrodes located on the display media;
wherein the printing device uses the algorithm to determine the location at which to print the second conductive trace on the display media, so that the second conductive trace connects to none of the plurality of electrodes other than the second electrode, and so that the second trace does not intersect with the first trace when viewed in a plan view.

20. The printer for printing on display media according to claim 18;
wherein the printing device uses the algorithm to determine the size of the display media and the location of the plurality of electrodes on the display media.

21. The printer for printing on display media according to claim 18;
wherein the printer includes a programming module which programs a display controller located on the display media.
